(19) United States
(12) Patent Application Publication
(10) Pub. No.: US 2021/0037281 A1
(43) Pub. Date: Feb. 4, 2021

(54) Dynamic Buffer Control For Devices Based On Environmental Data

(71) Applicant: Google LLC, Mountain View, CA (US)

(72) Inventors: Shijing Xian, Sunnyvale, CA (US); Jeffrey Kuramoto, Mountain View, CA (US)

(73) Assignee: Google LLC, Mountain View, CA (US)

(21) Appl. No.: 16/605,691

(22) PCT Filed: Oct. 18, 2018
(86) PCT No.: PCT/US2018/056489

§ 371 Date: Oct. 16, 2019

(51) Int. Cl. H04N 21/439; H04W 4/80; H04N 21/4363; H04N 21/44; H04N 21/442; H04N 21/466; H04N 21/41; G06N 20/00; G06N 5/04

(52) U.S. Cl. CPC H04N 21/4392; H04W 4/80; H04N 21/43637; H04N 21/44004; G06N 5/04; H04N 21/4662; H04N 21/4104; G06N 20/00; H04N 21/44209

(57) ABSTRACT

A buffer size of an electronic media accessory, such as a wireless audio or video player, is dynamically adjusted based on machine learning optimizations balancing low latency and high media quality. A host device that is wirelessly paired with the electronic media accessory may detect various environmental conditions, and communicate a recommended buffer size to the electronic accessory based on such conditions. The electronic accessory adjusts its buffer in accordance with the recommended size, thereby achieving a latency of approximately 100 ms or less in good RF conditions.

### BACKGROUND

Electronic devices often have high audio latency for streaming over short range wireless connections, such as Bluetooth. For example, audio streamed from one device to another over a Bluetooth connection according to the Advanced Audio Distribution Profile (A2DP) may have a latency of 250 ms or above. One cause for such latency may be multiple buffer queues. For example, an operating system may have multiple buffer queues across its Bluetooth stacks and controller, because different applications have different requirements for latency, and in general audio quality is more important for latency. Audio pipelines are typically set up to optimize for audio stutter instead of latency. Another possible cause is changing radio frequency (RF) conditions. For example, RF conditions can change dramatically, and in some cases, audio is received with a high jitter. As such, each of a transmitting device, such as a phone, and a receiving device, such as an earbud, may need to reserve a large buffer to handle the jitter for some worst cases.

High audio latency causes audio/video synchronization issues, especially for some implementations, such as video games, where video content can move at a high rate, and delays between audio effects and correlating video content are easily detectable and can significantly reduce a quality of user experience. Audio latency can also affect audio/video synchronization for streaming video, as many devices do not support delay reporting which adjusts playback to account for audio buffering.

### BRIEF SUMMARY

The present disclosure relates to dynamically adjusting a buffer size of an electronic audio accessory base on machine learning optimizations balancing low latency and high audio quality. A host device that is wirelessly paired with an electronic audio accessory may detect various environmental conditions, and communicate a recommended buffer size to the electronic accessory based on such conditions. The electronic accessory adjusts its buffer in accordance with the recommended size, thereby achieving a latency of approximately 100 ms or less in good RF conditions.

One aspect of the disclosure provides a method for short range wireless media reception, including receiving, by an electronic media accessory, a recommended buffer size from a host device, setting a buffer of the electronic media accessory based on the recommended buffer size, receiving media over short range wireless signals from the host device, buffering the received media in the buffer of the electronic media accessory, playing the received media through the electronic media accessory, and providing feedback information to the host device. The method may further include receiving an updated recommended buffer size from the host device when one or more conditions change, and adjusting the buffer of the electronic media accessory based on the updated recommended buffer size. The one or more conditions may include, for example, environmental conditions, such as location information, activity information, or connectivity information. Providing feedback information may include providing media playback quality information to the host device, wherein the media playback quality information includes at least one of received signal strength indicators (RSSI), media packet jitter, number of gaps, or buffer level metrics. Receiving the recommended buffer size may include receiving a communication over a Bluetooth channel.

Another aspect of the disclosure provides a method for short range wireless media transmission, including receiving, by a computing device, initial environmental information, determining a recommended buffer size for an electronic media accessory that is wirelessly paired with the computing device, wherein the recommended buffer size is based at least partially on the initial environmental information, communicating the recommended buffer size to the electronic media accessory, and providing media signals to the electronic media accessory over a short range wireless communication channel. The method may further include determining whether one or more conditions have changed, when the one or more conditions have changed, determining an updated buffer size based on the changed condition, and communicating the updated buffer size to the electronic media device. Even further, the method may include receiving updated environmental information, wherein determining whether the one or more conditions have changed comprises determining whether the updated environmental information is different from the initial environmental information. The method may include receiving feedback information from the electronic media accessory, wherein determining whether the one or more conditions have changed is at least partially based on the feedback information, wherein the feedback information from the electronic media accessory may include media playback quality information. The media playback quality information may include at least one of received signal strength indicators (RSSI), media packet jitter, number of gaps, or buffer level metrics. Determining the recommended buffer size may include collecting a training set of environmental information, collecting a training set of feedback information from one or more electronic media devices, and generating a table correlating combinations of environmental information and feedback information with recommended buffer sizes.

Yet another aspect of the disclosure provides an auxiliary device, including a wireless communication interface adapted to receive media packets over a wireless connection, an adjustable mediabuffer adapted to temporarily store the received mediapackets, a speaker adapted to playback the media packets temporarily stored in the adjustable media buffer, and a processor in communication with the adjustable mediabuffer, the processor configured to set a size of the adjustable media buffer based on conditions surrounding the auxiliary device. The processor may be further configured to provide feedback information relating to the adjustable media buffer to a host device. The feedback information may include at least one of received signal strength indicators (RSSI), media packet jitter, number of media gaps, or buffer level metrics. The processor may be further configured to receive a recommended buffer size from a host device, and adjust the buffer based on the recommended buffer size. The auxiliary device may further include one or more sensors for detecting the conditions, such as location information, activity information, or connectivity information.

### BRIEF DESCRIPTION OF THE DRAWINGS

FIG. 1 is a pictorial diagram of an example system according to aspects of the disclosure.

FIG. 2 is a pictorial diagram of another example system according to aspects of the disclosure.

FIG. 3 is a block diagram of the system of FIG. 2.

FIG. 4 is a flow diagram of a process according to aspects of the disclosure.

FIG. 5 is a block diagram of an example system according to aspects of the disclosure.

FIG. 6 is a block diagram of an example auxiliary device according to aspects of the disclosure.

FIG. 7 is a flow diagram illustrating an example method of using machine learning to generate a policy for buffer size adjustment according to aspects of the disclosure.

FIG. 8 is a flow diagram illustrating an example method of determining a buffer size by a host device according to aspects of the disclosure.

FIG. 9 is a flow diagram illustrating an example method of adjusting a buffer size by an auxiliary device according to aspects of the disclosure.

### DETAILED DESCRIPTION

### Overview

The technology relates to dynamically adjusting a buffer size of an electronic media accessory, such as an earbud, headset, speaker, display, etc., based on environmental conditions. A companion device, such as a mobile phone, that is wirelessly paired with the accessory may detect various environmental conditions, such as location, activity, connectivity, etc. Based on such conditions, the companion device communicates a recommended buffer size to the electronic accessory, which in turn adjusts its buffer in accordance with the recommended size. The recommended sizes may be determined using machine learning techniques applied to collected data. While the present disclosure describes adjusting the buffer size of a media playback device with regard to transmission and playback of audio packets in many examples, it should be understood that such examples also apply to transmission, buffering, and playback of video packets or other types of packets.

Determination of the recommended buffer sizes may include a training component, utilizing machine learning techniques to find a suggested buffer size for each of various combinations of detected environmental factors. For example, an application running on the companion device may receive regular communication from the electronic accessory. The regular communication may take place over radio frequency communication (RFCOMM) channels, Bluetooth low energy (BLE) channels, or the like. When A2DP is streaming, the electronic accessory sends RF-related data, such as received signal strength indicators (RSSI), audio packet jitter, number of audio gaps the Bluetooth device has during A2DP streaming, buffer level metrics, etc. to the application on the companion device. The buffer level metrics may include, for example, information regarding buffer size of the accessory, such as target buffer level size, current buffer level size, minimum buffer level size, etc.

The application collects the received data statistically for training, and logs environmental information. Examples of such environmental information may include locations, activities, RF activity, etc. Locations may be specific and/or categorical. By way of example only, the location may be a particular restaurant, or restaurants categorically. Other examples include in a car, outdoors, etc. Example activities may include sitting still, walking, running, driving, etc. Current RF activity may identify Bluetooth devices that are connected, wireless network activity, or the like.

The collected data may be analyzed by the application, or it may be uploaded to another computing device, such as a server or a plurality of computing devices in a distributed network, for analysis. During the analysis, a table is generated that contains a map of the various combinations of environmental information and corresponding buffer sizes recommended for each combination of environmental factors.

Recommendation of a suggested buffer size to the electronic accessory in operation may include an execution component, which utilizes the buffer sizes determined during the training phase. For example, when A2DP starts, the application may send a recommended buffer size to the electronic accessory based on detected environmental information and the table generated during the training phase.

The electronic accessory may continue to report media quality information to the companion device. Further, the companion device may continue to detect other environmental information, such as activity, location, connected devices, etc. Accordingly, as the environment changes, the application may update the recommended buffer size. For example, if the environment changes for the worse, such as if an RF condition deteriorates or the electronic accessory runs into audio stutter exceeding a threshold, the application may recommend an increased buffer size. The electronic accessory increases its buffer size by, for example, using sampling rate adjustment (SRA) to slowly inject audio samples. As another example, the environmental conditions may improve such that the electronic accessory can operate efficiently with a reduced buffer size. For example, if RSSI improves, jitter reduces, etc., a buffer size may be reduced to reduce latency. In this regard, SRA may be used to slowly remove audio samples to decrease the buffer.

In some examples, the electronic accessory may adjust its buffer size without receiving a recommendation from the companion device. For example, the accessory may detect a change in conditions. By way of example only, such change may be determined based on audio stutter. Upon detection of such change, the electronic accessory may automatically adjust its buffer size to accommodate for the updated condition.

By dynamically adjusting the buffer size, the electronic accessory is able to provide a high quality audio or video signal with a lowest amount of latency. For applications such as video streaming and gaming, this provides an enhanced user experience as the audio heard by the user through the electronic accessory will closely match the video seen by the user through the companion device.

### Example Systems

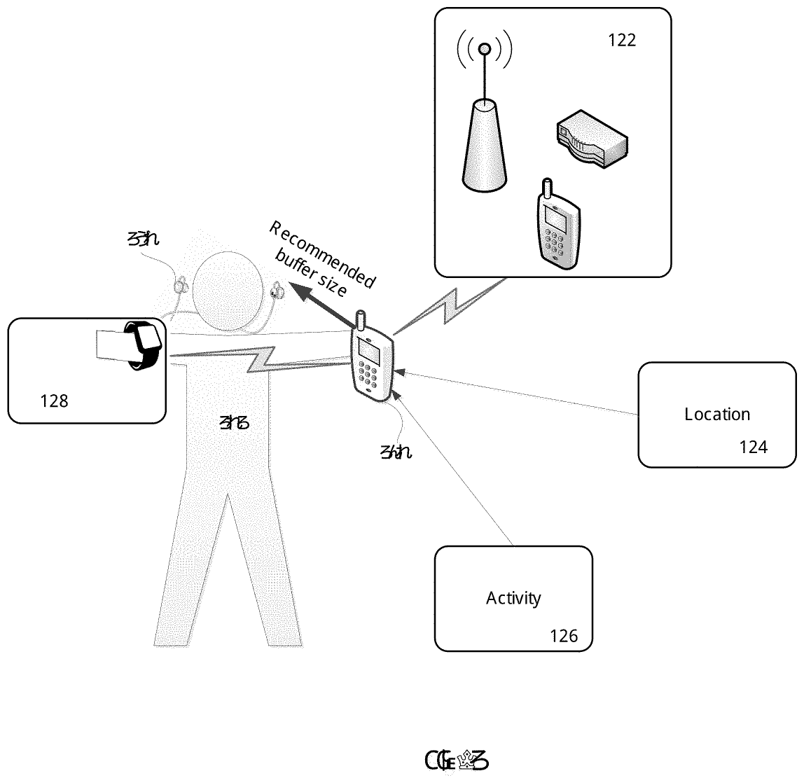

FIG. 1 is a pictorial diagram of an example system in use. A user 101 holds mobile computing device 170 and wears auxiliary device 180. The mobile computing device 170 detects surrounding conditions, such as signals from other devices 122, location 124, activity 126, other short range wireless connections 128, etc. Based on such detected conditions, the mobile device 170 determines a recommended buffer size for the auxiliary device 180, and communicates the recommended buffer size to the auxiliary device 180. The auxiliary device 180 adjusts its buffer size based on the recommendation. The auxiliary device 180 can continue to adjust its buffer size as it receives media information from the mobile computing device 170 over the short range wireless connection. For example, the auxiliary device 180 can automatically adjust in response to conditions it detects, such as media playback quality. In other examples, the auxiliary device 180 can adjust in response to receiving updated recommendations from the mobile computing device 170.

In the example shown, the auxiliary device 180 is a pair of wireless earbuds. However, it should be understood that the auxiliary device 180 may be any of a number of different types of audio devices, video devices, or other wireless media playback devices. For example, the auxiliary device 180 may be a pair of fully wireless earbuds, a headset, a head-mounted display, a wireless speaker, etc.

The mobile computing device 170 may be, for example, a mobile phone, tablet, laptop, gaming system, or any other type of mobile computing device. In some examples, the mobile computing device 170 may be coupled to a network, such as a cellular network, wireless Internet network, etc. The mobile computing device 170 may store machine learning policies for determining the recommended buffer sizes. For example, the mobile computing device 170 may store one or more tables or other data structures correlating combinations of different conditions with particular buffer sizes. Such tables or data structures may be generating through machine learning processes. According to other examples, the mobile computing device 170 may access such machine learning policies from a remote source.

The signals from other devices 122 may include signals from any of a variety of types of devices detectable by the mobile device 170. For example, such devices may include access points, other mobile devices, radio frequency identification (RFID) tags or scanners, wireless routers, etc. In addition to detecting the devices, such as by address information in the received signals, the mobile computing device 170 may also detect received signal strength providing an indication of location of the devices with respect to the mobile computing device 170.

Location information 124 may be detected in other ways, in addition or in the alternative to the received signals from other devices. For example, location may be detected based on global position satellite (GPS), recognition of text captured at the location, recognition of other objects in images captured at the location, sensor data, etc. The detected location 124 can be categorical information, such as at a restaurant, outdoors, indoors, in an office building, etc. In other examples, the detection location 123 can be more specific, such as by specifying a city, geographical coordinates, or other indication of a geographical location. To protect user privacy, such location information need not be reported to any entity other than the user's own mobile computing device 170. If the user authorizes transmission of the location information to other entities, such as to a server for machine learning computations, additional protections of user privacy are implemented, such as anonymization, aggregation, etc.

The activity 126 may be determined based on information from one or more sensors of the mobile computing device 170. For example, the activity may be determined based on accelerometer data indicating that the device 170 is moving at a particular rate of speed. Such accelerometer data may correspond to jogging, cycling, riding in a car, riding on a train, etc. According to some examples, combinations of different types of sensor data may help to determine the activity. For example, lateral speed, vibrations, location, and/or an application running on the mobile computing device 170 may indicate that the user is jogging.

The other short range wireless connections 128 may identify other connection with the mobile device 170, such as smartwatches, specialized controllers, or any other devices. While several examples of conditions are provided, it should be understood that these just examples and that numerous other conditions may be detected and used for determining buffer size.

Though not shown in FIG. 1, the auxiliary device 180 may also provide feedback to the mobile computing device 170 for use in determining a recommended buffer size. For example, such feedback may include information regarding media playback quality, such as jitter, stutter, delay, etc. Such feedback may alternatively or additionally include other buffer metrics, such as current buffer size, target buffer size, etc. The mobile device 170 may continue to detect conditions, including the feedback, and provide updated buffer size recommendations based on the detected conditions. The updated recommendations may be provided continuously, periodically, or in response to predetermined events, such as changes in conditions.

In other examples, the auxiliary device 180 may also detect conditions, and may update its buffer size in response to such conditions, with or without a recommendation from the mobile device 170. For example, the auxiliary device 180 may detect an amount of audio stutter or other indications of low playback audio quality and automatically increase the buffer size.

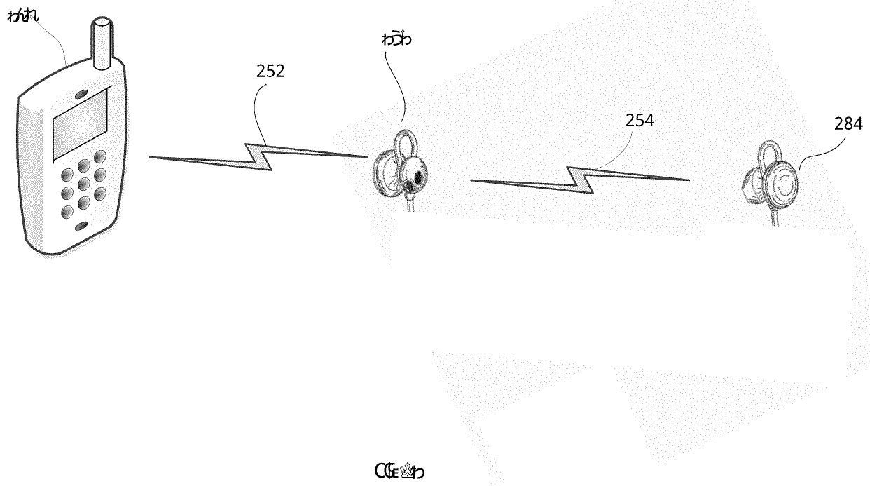

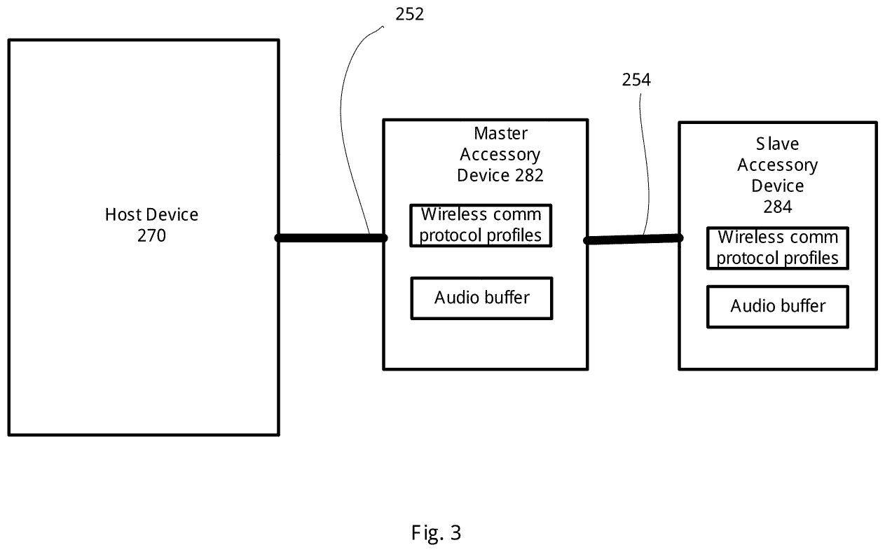

FIGS. 2-3 illustrate an example system 200 including a host device 270, such as a mobile computing device, communicatively coupled to an electronic accessory. In this example, the electronic accessory is a fully wireless pair of earbuds, including a master earbud 282 and a slave earbud 284. The host device 270 is coupled directly to the master earbud 282 via wireless communication link 252, while the master earbud 282 is further communicatively coupled to slave earbud 284 via wireless communication link 254. The links 252, 254 between the devices may be, for example, short range wireless pairing links, such as Bluetooth, near field magnetic induction communication (NFMI), etc. For example, links 252, 254 may be asynchronous connectionless links (ACLs).

The master and slave earbuds 282, 284 may each store information, such as wireless communication protocol profiles. Examples of such profiles may include audio/video remote control profile (AVRCP), hands free profile (HFP), advanced audio distribution profile (A2DP), attribute profile (ATT), device ID profile (DIP), proximity profile (PXP), synchronization profile (SYNCH), radio frequency communication (RFCOMM), Bluetooth low energy (BLE), or the like. The profiles may dictate how the earbuds 282, 284 operate. For example, the profiles may contain information regarding dependencies on other formats, suggested user interface formats, parts of a protocol stack used by the profile, etc. In some examples, the profiles may determine how the master earbud 282 communicates with the host device 270. By way of example, the profiles may define how audio is streamed from the host device 270 to the master device 282, and/or from the master device 282 to the slave device 284.

The earbuds 282, 284 may further include audio buffers for temporarily storing audio information received from the host device 270 prior to playback through the earbuds 282, 284. The audio buffers are adjustable in that the earbuds 282, 284 can adjust an amount of data that is buffered prior to playback. For example, buffer size may be increased using sampling rate adjustment (SRA) to slowly inject audio samples, or reduced by using SRA to slowly remove audio samples. Increasing the audio buffer may improve playback quality, while decreasing the buffer may reduce latency.

Depending on the type of master and slave devices used and the types of functionality, other types of buffers may additionally or alternatively be present. For example, other media playback devices, such as displays, may include video buffers for temporarily storing video packets received over a wireless connection from the host, where the video buffers are adjustable. According to some examples, the earbuds 282, 284 may also store machine learning policies indicating how the buffers should be adjusted under particular conditions.

While the host device 270 in this example is illustrated as a mobile phone, it should be understood that the host device may be any of various types of devices adapted to transmit media signals, such as audio or video signals, etc. For example, the host device may be a tablet, smart watch, game system, music player, laptop, personal digital assistant device, or any other computing device. Similarly, the first and second accessories, while here shown as earbuds 282, 284, may in other examples be any combination of speakers or other audio devices, video output displays, etc. The first and second accessories may be paired during a time of manufacture, or may be sold separately and paired later by a user.

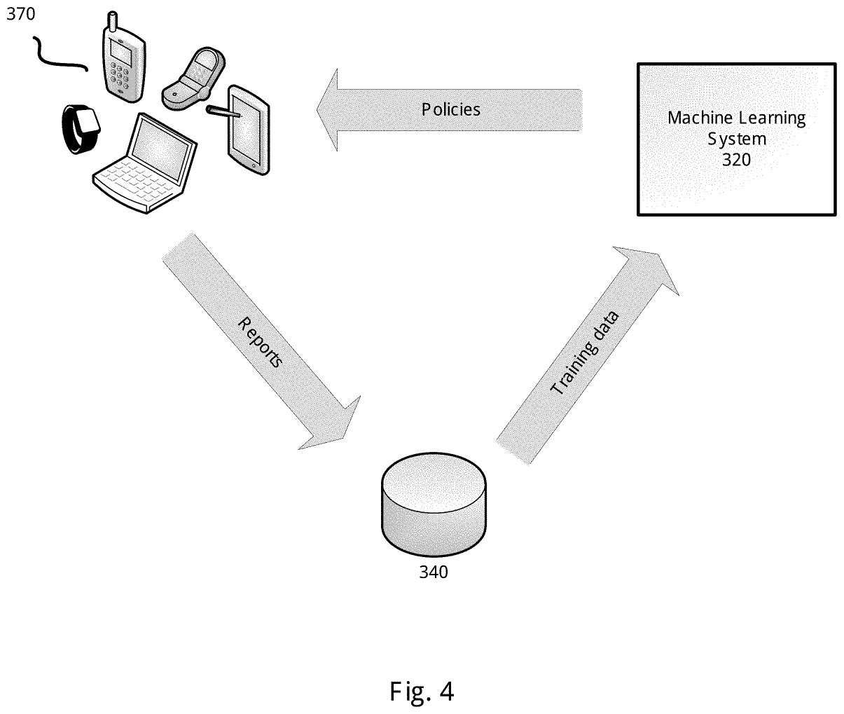

FIG. 4 is an example flow illustrating generation of machine learning policies correlating various combinations of conditions with recommended buffer sizes. Various data gathered by mobile devices 370, with user permission, is transmitted to database 340. The database 340 may collect data from various sources over an extended period of time.

All or a portion of the data stored in database 340 may be used by machine learning system 320 as training data to identify buffer sizes providing a best performance under particular conditions. For each of numerous possible combinations of conditions, a corresponding buffer size may be identified. The corresponding buffer sizes may be identified in a machine learning policy, such as a set of rules, a table, or some other structure that may be accessed by the mobile devices 370 before and/or during media playback operations. For example, the policy may be downloaded and stored on the mobile devices 370. In other examples, the policy may be stored remotely, such as on a server, and accessed by the mobile devices 370 when needed.

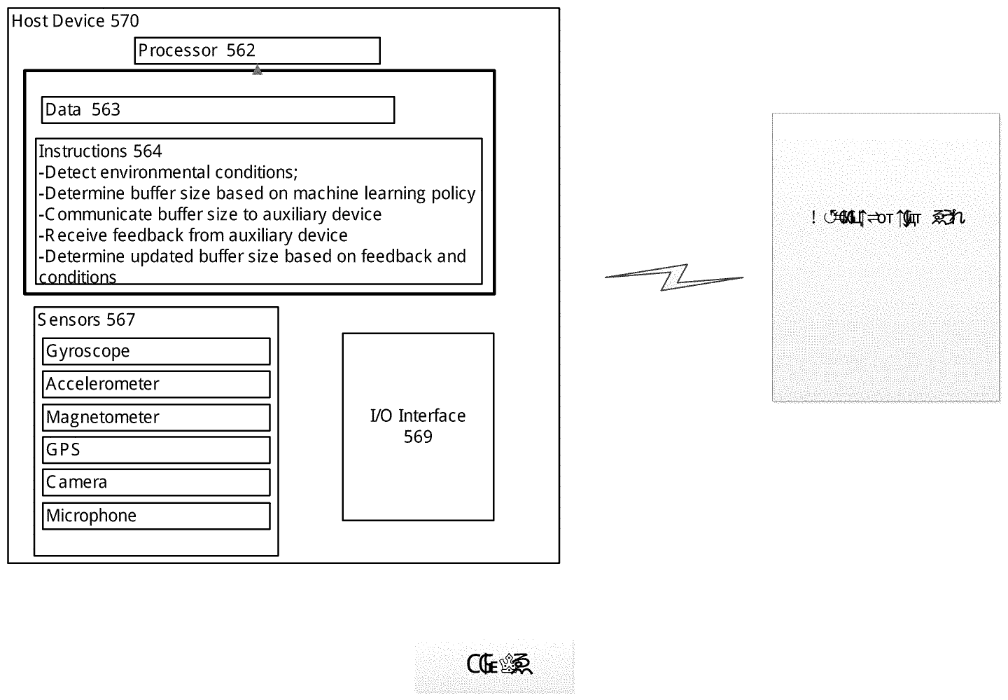

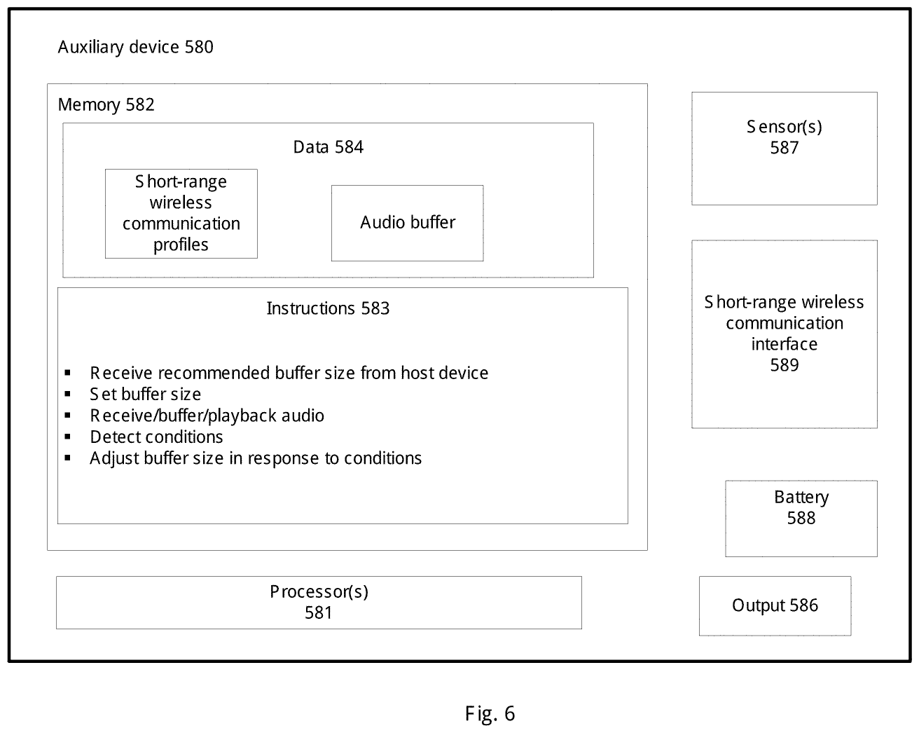

FIG. 5 is a block diagram of a system including a host device 570 in communication with an auxiliary device 580, illustrating the internal components of the host device 570. The internal components of the auxiliary device 580 are illustrated in FIG. 6. While a number of such internal components are shown, it should be understood that such components are merely non-limiting examples, and that other components may additionally or alternatively be included.

Host device 570 includes processor 562, memory including data 563 and instructions 564, and one or more sensors 567. The one or more processors 562 may be any conventional processors, such as commercially available microprocessors. Alternatively, the one or more processors may be a dedicated device such as an application specific integrated circuit (ASIC) or other hardware-based processor. Although FIG. 5 functionally illustrates the processor, memory, and other elements of host 570 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of host 570. Accordingly, references to a processor or computing device will be understood to include references to a collection of processors or computing devices or memories that may or may not operate in parallel.

Memory may store information that is accessible by the processors 562, including instructions 564 that may be executed by the processors 562, and data 563. The memory may be of a type of memory operative to store information accessible by the processors 562, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 564 and data 563 are stored on different types of media.

Data 563 may be retrieved, stored or modified by processors 562 in accordance with the instructions 564. For instance, although the present disclosure is not limited by a particular data structure, the data 563 may be stored in computer registers, in a relational database as a table having a plurality of different fields and records, XML documents, or flat files. The data 563 may also be formatted in a computer-readable format such as, but not limited to, binary values, ASCII or Unicode. By further way of example only, the data 563 may be stored as bitmaps comprised of pixels that are stored in compressed or uncompressed, or various image formats (e.g., JPEG), vector-based formats (e.g., SVG) or computer instructions for drawing graphics. Moreover, the data 563 may comprise information sufficient to identify the relevant information, such as numbers, descriptive text, proprietary codes, pointers, references to data stored in other memories (including other network locations) or information that is used by a function to calculate the relevant data. According to some examples, the data 563 may store machine learning policies for identifying a recommended buffer size corresponding to a particular set of conditions.

The instructions 564 may be executed to detect conditions, such as environmental conditions, using one or more sensors 567. The conditions may further include playback quality conditions communicated by the auxiliary device 480, for example, and received through I/O interface 569. The instructions 564 may further provide for determining a recommended buffer size based on the detected conditions, and communicating the recommended buffer size to the auxiliary device 480.

The sensors 567 may include, by way of example and not limitation, a gyroscope, accelerometer, magnetometer, GPS, camera, microphone, light sensor, motion sensor, etc. Such sensors may be used to detect a variety of different conditions, such as movement, weather conditions, sounds, nearby objects, electromagnetic fields, etc. The sensors 567 may in some examples recognize detailed information relating to the conditions. For example, the gyroscope and accelerometer may not only detect whether the device 560 is moving or not, but may determine whether the movement is linear or rotational, a direction of the movement, a speed of the movement, etc. Information from different types of the sensors 567 may also be used to determine conditions or activities. For example, a low reading from a light sensor in combination with a high pressure reading from a barometer may indicate rain. As another example, a particular speed and level of vibration may indicate that the device 560 is traveling on a bicycle, while received sounds indicate that the device 560 is in a city.

The device 560 further includes an input/output (I/O) interface 569. I/O interface 569 may provide for communication, using analog or digital modulation, between the computing device 560 and other devices or networks. The I/O interface 569 may facilitate circuit-switched and/or packet-switched communication. For instance, I/O interface 569 may include a chipset and antenna arranged for wireless communication with a radio access network or an access point. I/O interface 569 may include a wireline interface, such as an Ethernet, Universal Serial Bus (USB), or High-Definition Multimedia Interface (HDMI) port. I/O interface 569 may also include a wireless interface, such as a Wi-Fi, or wide-area wireless interface (e.g., WiMAX or 3GPP Long-Term Evolution (LTE)). Other forms of physical layer interfaces and other types of communication protocols may also be used. Furthermore, I/O interface 569 may comprise multiple physical communication interfaces (e.g., a Wifi interface, a short range wireless interface, and a wide-area wireless interface), and may enable multiple simultaneous connections of different types.

The I/O interface 569 may be used to establish connectivity with one or more other computing devices. For example, the I/O interface 569 may be used to establish connections with access points, such as cellular access points 220, Wi-Fi access points 225, or any other type of access point with which the device 560 may establish a connection. The I/O interface may further establish connection with one or more other mobile computing devices 232, 234. The I/O interface 569 may further be used to detect beacons or radio frequency identification (RFID) tags, which may be positioned at any of a number of locations for any of a variety of reasons. For example, such beacons or RFID tags may be positioned in stores to determine a number of potential customers, in an advertising space to determine a number of viewers of the advertisement, etc.

I/O interface 569 may be used to determine connectivity information, which may further be used to determine conditions or activities associated with the device 560. For example, a number of other computing devices moving in close proximity with the device 560 may suggest that the device 560 is on a public train or a busy sidewalk. More precise determinations can be made when combined with other sensor information, such as noise level, vibrations, speed, etc. As another example, a number of other detected computing devices in close proximity, but a weak GPS signal, may suggest that the device 560 is indoors. In further examples, an identification of a particular access point, such as a MAC address, may provide location information or suggest a particular activity, such as exercising at a fitness club associated with the MAC address of the access point.

While several examples of how various types of detected information can be used separately or in combination to determine conditions surrounding the device 560 or activities, it should be understood that any number of various activities or conditions can be determined using various inputs. It should also be understood that the device 570 may include other components which are not shown, such charging input for a battery, signals processing components, etc. Such components may also be utilized in execution of the instructions 564.

The auxiliary device 580 is illustrated in further detail in FIG. 6. Auxiliary device 580, such as earbuds, may also include one or more processors 581, memory 582 including instructions 583 and data 584, and a wireless communication interface 589. In some examples, the auxiliary device 580 includes one or more sensors 587. The auxiliary device 580 may further include other components typically present in earbuds and other electronic accessories, such as output 586 and battery 588. In the example of earbuds, the output 596 may be speakers, though in other auxiliary devices the output may include other components such as a display, etc. While a few components of the auxiliary device 580 are shown, it should be understood that the device may include any number of additional components that are typically provided in auxiliary devices.

The processor 581 and memory 582 may be any of a variety of different types, similar to those discussed above in connection with the host device 570. For example, memory 582 may be of any type capable of storing information accessible by the processor(s), including a computing device-readable medium, or other medium that stores data that may be read with the aid of an electronic device, such as a volatile memory, non-volatile as well as other write-capable and read-only memories. By way of example only, memory 420 may be a static random-access memory (SRAM) configured to provide fast lookups. Systems and methods may include different combinations of the foregoing, whereby different portions of the instructions and data are stored on different types of media.

The memory 582 may further include a buffer, such as an audio buffer, such as in the data 584. In some examples the memory 582 may further include short range wireless communication profiles, such as Bluetooth profiles.

The instructions 583 may be any set of instructions to be executed directly (such as machine code) or indirectly (such as scripts) by the one or more processors 581. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance.

The instructions 583 may be executed to adjust the buffer. For example, the auxiliary device 580 may receive a recommended buffer size from the host device 570, and set the buffer accordingly. The auxiliary device 580 receives audio from the host device 570 over a wireless connection, such as a short range wireless pairing through interface 589. The auxiliary device 580 buffers the received audio using the set buffer size, and outputs the received audio through output 586. The instructions 583 may be further executed to detect conditions. For example, detecting conditions may include detecting indicators of playback quality, such as stutter, etc. In some examples, detecting conditions may include detecting environmental conditions using sensors 587, such as detecting a presence of other devices. Detecting conditions may alternatively or additionally include detecting receipt of updated recommendations regarding buffer size from the host device 570. The auxiliary device 580 may adjust its buffer size in response to the detected conditions.

The one or more processors 581 may be microprocessors, logic circuitry (e.g., logic gates, flip-flops, etc.) hard-wired into the device 580 itself, or may be a dedicated application specific integrated circuit (ASIC). It should be understood that the one or more processors 430 are not limited to hard-wired logic circuitry, but may also include any commercially available processing unit, or any hardware-based processors, such as a field programmable gate array (FPGA). In some examples, the one or more processors 581 may include a state machine. The processors 581 may be configured to execute the instructions 583.

The one or more sensors 587 may include any of a variety of mechanical or electromechanical sensors for detecting conditions relevant to adjusting buffer size. Such sensors may include, for example, an accelerometer, gyroscope, light sensor, barometer, audio sensor (e.g., microphone), vibration sensor, heat sensor, radio frequency (RF) sensor, etc. As another example, the sensors may detect other parameters, such as battery life, signal quality, movement, etc. In this regard, the device 580 may detect conditions indicating that the device should adjust its buffer size to improve playback quality and/or battery life or other parameters.

The short range wireless pairing interface 589 may be used to form connections with other devices, such as the host device, such as a mobile phone providing the media packets. The connection may be, for example, a Bluetooth connection or any other type of wireless pairing. By way of example only the connection may include an ACL link

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

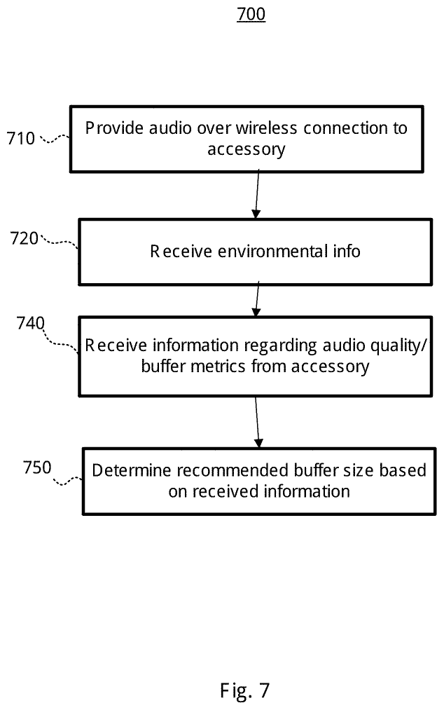

FIG. 7 is a flow diagram illustrating an example method 700 of using machine learning to generate a policy for buffer size adjustment according to aspects of the disclosure. The method may be performed at, for example, a host computing device, such as the mobile computing device 170 of FIG. 1 or any other wired or wireless computing device. In other examples, the method may be performed by the host computing device in communication with a remote server adapted to collect information from a plurality of mobile computing devices.

In block 710, the host computing device provides media to an electronic accessory over a wireless connection, such as a short range wireless connection. The accessory may be, for example, an audio or video output accessory, such as earbuds, wireless speakers, head-mounted display, etc.

In block 720, the host computing device receives environmental information, such as through one or more sensors. For example, the host computing device may receive information regarding nearby devices, such as signal strength, address, etc. As another example, the host computing device may receive information such as motion information, location information, light/noise levels, etc. Based on such information, the host computing device may infer further information, such as an activity performed by a user of the host device.

In block 730, the host device may receive information regarding media quality and/or buffer metrics from the electronic accessory. For example, the host device may receive from the accessory information regarding buffer size of the accessory, such as target buffer level size, current buffer level size, minimum buffer level size. The host device may further receive from the accessory feedback regarding media playback quality, including jitter, stutter, gaps, etc.

In block 740, a recommended buffer size may be determined based on such received information. For example, a remote server may collect such information from a plurality of host computing devices, and analyze such information to detect correlations between different combinations of detected conditions and a minimum buffer size used to payback media meeting a threshold quality level. Accordingly, a chart, table, or other policy correlating the conditions to the buffer size may be generated based on the analysis. According to other examples, the analysis may be performed on the host device, such as by using a smaller set of training data. The generated policy may be used in future iterations of supplying media to an electronic accessory and providing recommendations to the accessory regarding a buffer size to use for playback of the media.

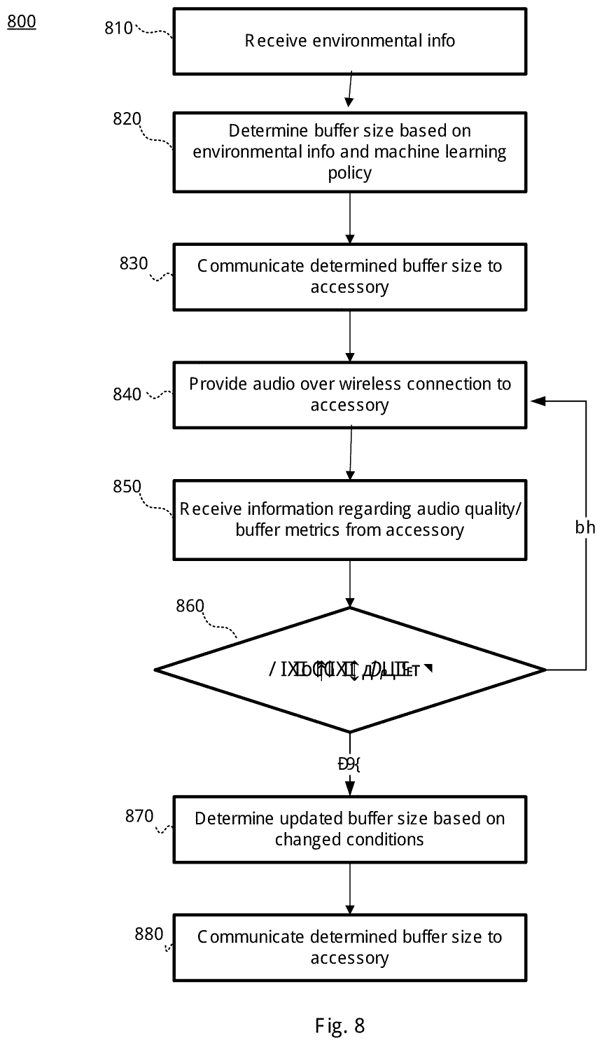

FIG. 8 is a flow diagram illustrating an example method 800 of determining a buffer size by a host device according to aspects of the disclosure. In block 810, the host device receives environmental information, such as through one or more sensors. In block 820, the host device determines a recommended buffer size for an electronic accessory based on the received environmental information and a machine learning policy, such as the policy generated in block 740 of FIG. 7.

In block 830, the host device communicates the recommended buffer size to the electronic accessory. For example, the host device may transmit the information over a Bluetooth connection or other wireless connection between the host device and the accessory.

In block 840, the host provides media over the wireless connection to the accessory. In block 850, the host receives feedback from the accessory, such as information regarding playback quality, latency, buffer size, or the like.

In block 860, the host device determines whether conditions have changed. This may include a change in environmental conditions, a change in media playback quality, or other changes. It may also include improvements or deterioration. For example, the host device may detect that the RF condition deteriorated as a result of interference or a change in the user' s location or activities, or that the accessory ran into audio stutter that exceeds a threshold. As another example, the host device may detect that the RF condition improved as a result of improved RSSI, reduced jitter, or the like. If there is no change, the host may continue sending media to the accessory in block 840.

When a change is the conditions is detected in block 860, an updated buffer size may be determined in block 870 based on the changed conditions. For example, an increased buffer size may be recommended for a deteriorated RF condition, while a reduced buffer size may be recommended for an improved RF condition. In block 880, the updated buffer size is communicated to the accessory, and the accessory may adjust its buffer accordingly.

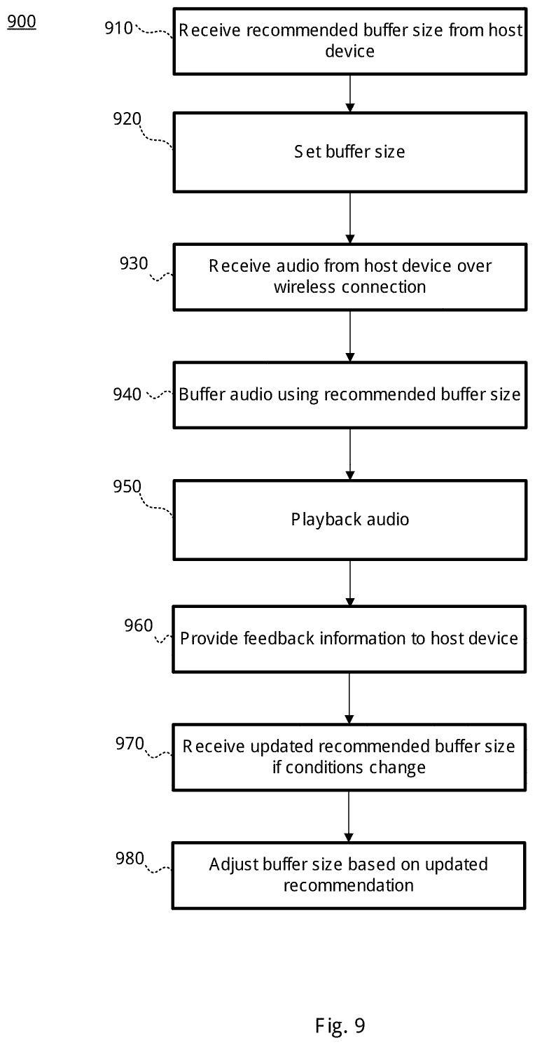

FIG. 9 is a flow diagram illustrating an example method 900 of adjusting a buffer size by an auxiliary device, such as an electronic accessory, for playing media.

In block 910, the auxiliary device receives a recommended buffer size from a host device, and sets its buffer accordingly in block 920. For example, the auxiliary device may define how much data will be stored in its buffer before playback begins.

In block 930, the auxiliary device receives media from the host device over the wireless connection. In block 940, the auxiliary device buffers the received media using the recommended buffer size, and plays back the media in block 950.

In block 960, the auxiliary device provides feedback information to the host device. The feedback information may relate to a quality of the media playback. In some examples, the feedback information may include buffer metrics, such as current buffer size, maximum or minimum buffer sizes, target buffer sizes, etc.

In block 970, the auxiliary device receives an updated recommended buffer size from the host device, such as if conditions change. The auxiliary device may accordingly adjust its buffer size in block 980. For example, when the RF condition deteriorates, the auxiliary device will dynamically increase the buffer to tolerate more jitters. This may be done, for example, using SRA to slowly inject audio samples to increase the buffer. In the example where the RF condition improves, the auxiliary device can decrease the buffer to the recommended buffer size to reduce latency. This may be done by using SRA to slowly remove audio samples.

In some examples, the auxiliary device may automatically adjust its buffer size, independent of any recommendations received from the host device. For example, the auxiliary device may detect a change in condition and dynamically increase or decrease its buffer accordingly, without waiting for commands from the host device.

While some of the above examples relate to transmitting audio over a wireless connection and adjusting an audio buffer, the systems and methods may similarly be applied to transmission and buffering of other types of media, such as video data or other data.

The foregoing techniques are advantageous in that they provide for dynamically and continually optimizing a buffer size for data transmitted over a wireless connection, such that target quality and latency levels may be achieved and balanced. For example, the machine learning may identify a highest possible audio quality at a threshold latency. In other examples, the machine learning may identify a lowest possible latency at a threshold quality level. In further examples, the machine learning may identify buffer sizes providing for target ranges of audio quality and latency. As conditions change, the buffer may be dynamically adjusted to accommodate the change. This provides for improved audio quality, increased battery life, enhanced user experience, and other benefits. In some examples, latency may be approximately 100 ms or less. Such benefits may be particularly noticeable in some uses, such as when a user is watching a video played on a screen of the host device while listening to the accompanying audio through the auxiliary device. By reducing the latency while maintaining an audio quality, the audio will more closely match the accompanying video.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for short range wireless media reception, comprising:
receiving, by an electronic media accessory, a recommended buffer size from a host device;
setting a buffer of the electronic media accessory based on the recommended buffer size;
receiving media over short range wireless signals from the host device;
buffering the received media in the buffer of the electronic media accessory;
playing the received media through the electronic media accessory; and
providing feedback information to the host device.

2. The method of claim 1, further comprising:
receiving an updated recommended buffer size from the host device when one or more conditions change; and
adjusting the buffer of the electronic media accessory based on the updated recommended buffer size.

3. The method of claim 2, wherein the one or more conditions include environmental conditions.

4. The method of claim 3, wherein the environmental conditions include at least one of location information, activity information, or connectivity information.

5. The method of claim 1, wherein providing feedback information comprises providing media playback quality information to the host device.

6. The method of claim 5, wherein the media playback quality information includes at least one of received signal strength indicators (RSSI), media packet jitter, number of gaps, or buffer level metrics.

7. The method of claim 5, wherein receiving the recommended buffer size comprises receiving a communication over a Bluetooth channel.

8. A method for short range wireless media transmission, comprising:
receiving, by a computing device, initial environmental information;
determining a recommended buffer size for an electronic media accessory that is wirelessly paired with the computing device, wherein the recommended buffer size is based at least partially on the initial environmental information;
communicating the recommended buffer size to the electronic media accessory; and
providing media signals to the electronic media accessory over a short range wireless communication channel.

9. The method of claim 8, further comprising:
determining whether one or more conditions have changed;
when the one or more conditions have changed, determining an updated buffer size based on the changed conditions; and
communicating the updated buffer size to the electronic media device.

10. The method of claim 9, further comprising:
receiving updated environmental information;
wherein determining whether the one or more conditions have changed comprises determining whether the updated environmental information is different from the initial environmental information.

11. The method of claim 9, further comprising:
receiving feedback information from the electronic media accessory;
wherein determining whether the one or more conditions have changed is at least partially based on the feedback information.

12. The method of claim 11, wherein the feedback information from the electronic media accessory comprises media playback quality information.

13. The method of claim 12, wherein the media playback quality information includes at least one of received signal strength indicators (RSSI), media packet jitter, number of gaps, or buffer level metrics.

14. The method of claim 8, wherein determining the recommended buffer size comprises:
collecting a training set of environmental information;
collecting a training set of feedback information from one or more electronic media devices; and
generating a table correlating combinations of environmental information and feedback information with recommended buffer sizes.

15. An auxiliary device, comprising:
a wireless communication interface adapted to receive media packets over a wireless connection;
an adjustable media buffer adapted to temporarily store the received media packets;
a speaker adapted to playback the media packets temporarily stored in the adjustable media buffer; and
a processor in communication with the adjustable media buffer, the processor configured to set a size of the adjustable media buffer based on conditions surrounding the auxiliary device.

16. The auxiliary device of claim 15, wherein the processor is further configured to provide feedback information relating to the adjustable media buffer to a host device.

17. The auxiliary device of claim 16, wherein the feedback information includes at least one of received signal strength indicators (RSSI), media packet jitter, number of media gaps, or buffer level metrics.

18. The auxiliary device of claim 15, wherein the processor is further configured to:
receive a recommended buffer size from a host device; and
adjust the buffer based on the recommended buffer size.

19. The auxiliary device of claim 15, further comprising one or more sensors for detecting the conditions.

20. The auxiliary device of claim 15, wherein the conditions include at least one of location information, activity information, or connectivity information.
